(19) United States
(12) Patent Application Publication
(10) Pub. No.: US 2008/0120607 A1
(43) Pub. Date: May 22, 2008

(54) System and method of web service description language transformation

(76) Inventor: Rob Dippel, Dunrobin (CA)

Correspondence Address: PEARNE & GORDON LLP, 1801 EAST 9TH STREET, SUITE 1200, CLEVELAND, OH, 44114-3108, US

(21) Appl. No.: 11/712,351

(22) Filed: Feb. 28, 2007

Related U.S. Application Data
(60) Provisional application No. 60/859,595, filed on Nov. 17, 2006.

(30) Foreign Application Priority Data
Nov. 17, 2006 (CA) 2,568,465

(51) Int. Cl. G06F 9/45

(52) U.S. Cl. 717/137

(57) ABSTRACT

A web service description language (WSDL) transformation system and method of transforming WSDL specifications into extensible markup language (XML) specifications are provided. The WSDL transformation system comprises a WSDL parser module for parsing a WSDL of a web service, a WSDL query module for querying the parsed WSDL, and a specification builder module for building a unified XML specification for the WSDL. The method comprises the steps of parsing a WSDL of a web service, querying the parsed WSDL and building a unified XML specification for the WSDL.

This application claims the benefit of U.S. Provisional Patent Application Ser. No. 60/859,595 filed Nov. 17, 2006, the contents of which are incorporated herein by reference in their entirety.

### FIELD OF THE INVENTION

The invention relates generally to web services and in particular to a system and method of web service description language transformation.

### BACKGROUND OF THE INVENTION

Web services are used in business intelligence (BI) systems to provide networked services. In current BI systems, it is possible to create event management component or processes for scheduled monitoring of events in the BI system. Such event management components are sometimes called agents or agent tasks, and can execute tasks in response to different types of events. One such task is to call a web service.

Using an agent task, a user enters a uniform resource locater (URL) to the web service description language (WSDL) description of a web service and available web services operations (also referred to as “methods”) that the web service can execute is displayed by the BI system. The user may pick a web service operation (or method) and the BI system displays the parameters required by that operation. The user can then input values for the parameters or map event data retrieved by the agent to fulfill the parameter values.

In other BI systems, it is possible for an agent to call a web service and map “agent event data” retrieved by the agent into the web service method's parameters. Unfortunately, this ability is restricted to remote procedure call (RPC) style web services, where the parameters of a web service method are a subset of the primitive data types as defined in the. W3C XML Schema as string, Boolean, float and double, and derived data types such as integer, long and int. Until recently, these data types were sufficient for mapping structured query language (SQL) or online analytical programming (OLAP) data from agent event data into web service parameters.

There are examples of products which display a user interface (UI) that allow users to enter data for web service methods (or operations) for primitive data types. One product allows a user to create a web service, and displays a page with a sample UI to enter parameters for the web service methods. When simple or complex types are used in defining the web service, the form to enter data is not available and displays an error message notifying the user that the form is only available for methods with primitive types or arrays of primitive types as parameters.

Unfortunately, there is no system or method of mapping SQL or OLAP data from agent event data into simple or complex data types. There is a need in the art for such a system and method.

### SUMMARY OF THE INVENTION

It is an object of the present invention to provide a system and method of web service description language transformation for mapping primitive and/or derived data types into web service parameters made up of simple or complex data types.

In accordance with an embodiment of the present invention, there is provided a web service description language (WSDL) transformation system for mapping web service parameters into primitive or derived data types. The WSDL transformation system comprises a WSDL parser module for parsing a WSDL of a web service, a WSDL query module for querying the parsed WSDL and a specification builder module for building a unified XML specification for the WSDL.

In accordance with another embodiment of the present invention, there is provided a method of mapping web service parameters into primitive or derived data types. The method comprises the steps of parsing a WSDL of a web service, querying the parsed WSDL and building a unified XML specification for the WSDL.

In accordance with another embodiment of the present invention, there is provided a memory containing computer executable instructions that can be read and executed by a computer for carrying out a method of mapping web service parameters into primitive or derived data types. The method comprises the steps of parsing a WSDL of a web service, querying the parsed WSDL and building a unified XML specification for the WSDL.

In accordance with another embodiment of the present invention, there is provided a carrier carrying a propagated signal containing computer executable instructions that can be read and executed by a computer. The computer executable instructions are used to execute a method of mapping web service parameters into primitive or derived data types. The method comprises the steps of parsing a WSDL of a web service, querying the parsed WSDL and building a unified XML specification for the WSDL.

### BRIEF DESCRIPTION OF THE DRAWINGS

These and other features of the invention will become more apparent from the following description in which reference is made to the appended drawings wherein:

FIG. 1 shows in component diagram an example of a web service description language (WSDL) transformation system for transforming WSDL specifications into extensible markup language (XML) specifications, in accordance with an embodiment of the present invention;

FIG. 2 shows in a flowchart an example of a method of transforming WSDL specifications into extensible markup language (XML) specifications, in accordance with an embodiment of the WSDL transformation system;

FIG. 3 shows in a flowchart an example of method of building a unified XML specification for a WSDL, in accordance with an embodiment of the XML transformation system;

FIG. 4 shows in a flowchart an example of a method of processing a schema type of an input message, in accordance with an embodiment of the WSDL transformation system;

FIG. 5 shows in a component diagram another example of a WSDL transformation system, in accordance with an embodiment of the present invention;

FIG. 6 shows in a flowchart another example of a method of transforming WSDL specifications into extensible markup language (XML) specifications, in accordance with an embodiment of the WSDL transformation system;

FIG. 7 shows in a component diagram an example of a system environment that may implement the WSDL transformation system;

FIG. 8 shows in a screenshot an example of a WSDL transformation system UI for a BI UI specification, in accordance with an embodiment of the WSDL transformation system; and

FIG. 9 shows in a screenshot an example of a user interface dialog, in accordance with an embodiment of the WSDL transformation system.

### DETAILED DESCRIPTION OF THE PREFERRED EMBODIMENTS

A system and method of the present invention will now be described with reference to various examples of how the embodiments can best be made and used. For convenience, like reference numerals are used throughout the description and several views of the drawings to indicate like or corresponding parts, wherein the various elements are not necessarily drawn to scale.

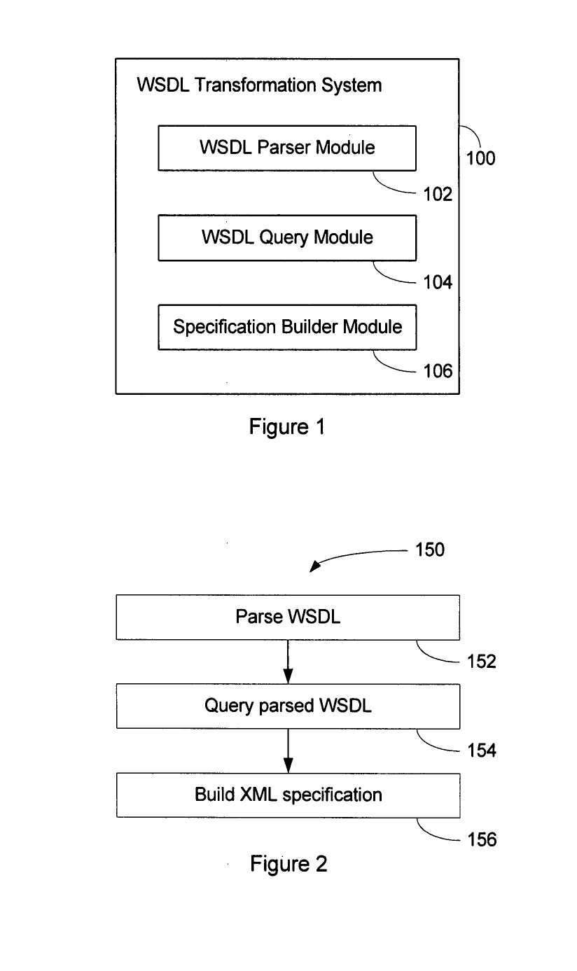

FIG. 1 shows in component diagram an example of a web service description language (WSDL) transformation system 100 for transforming WSDL specifications into extensible markup language (XML) specifications, in accordance with an embodiment of the present invention. The WSDL transformation system 100 comprises a WSDL parser module 102 for parsing a WSDL of a web service, a WSDL query module 104 for querying the parsed WSDL, and a specification builder module 106 for building a unified XML specification for the WSDL.

In this document, the term “unified XML specification” refers to a predetermined, simpler-than-WSDL specification that can describe both a document style web service or a remote procedure call (RPC) style web service. WSDL is an XML specification that may be used to describe both a document style web service or an RPC style web service. However, the unified XML specification uses a predetermined format for describing the web service features. Advantageously, the unified XML specification pulls together the schema data types that make up a simple or complex schema type in a hierarchical manner.

The WSDL parser module 102 parses the WSDL and ensures that it is complete and valid. The WSDL parser module 102 also creates a list of XML schema data types described in the WSDL (e.g., simple types, complex types).

The WSDL query module 104 provides a query interface to interrogate what services, bindings, ports, operations, and messages are available from the parsed WSDL, and what data types make up those messages.

The specification builder module 106 uses the WSDL query module 104 to interrogate the structure of a web service request described in the WSDL, and builds a well-formed XML document specification for that WSDL.

Other components may be added to the WSDL transformation system 100, including a hypertext markup language (HTML) builder module for converting the XML specification into an HTML “tree” control comprising HTML input elements for leaf data type nodes in the specification.

Advantageously, the WSDL transformation system 100 maps primitive and/or derived data types into web service parameters made up of simple and/or complex data types.

FIG. 2 shows in a flowchart an example of a method of transforming WSDL specifications into extensible markup language (XML) specifications (150), in accordance with an embodiment of the WSDL transformation system 100. The method (150) begins with parsing a WSDL of a web service (152). Next, the parsed WSDL is queried (154) to determine the services, bindings, ports, operations and messages of the WSDL, and what data types make up those messages. Next, a unified XML specification is built for the WSDL (156) based upon the queried information. Other steps may be added to the method (150), including the step of converting the XML specification into an HTML “tree” control comprising HTML input elements for leaf data type nodes in the specification.

Advantageously, the method (150) creates a common, simplified XML specification based on the web service WSDL, which can be used to map simple and complex XML schema data types to HTML constructs for display in a BI UI.

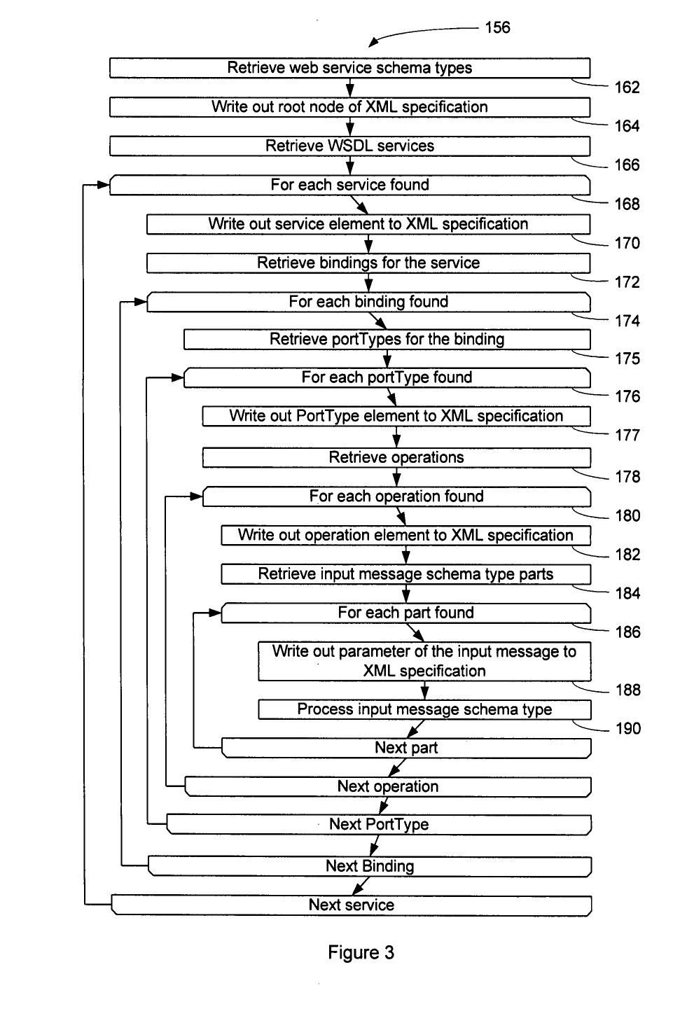

FIG. 3 shows in a flowchart an example of method of building a unified XML specification for a WSDL (156), in accordance with an embodiment of the XML transformation system 100. The method follows the steps of parsing a WSDL (152) and querying the parsed WSDL (154) to retrieve the web service schema types of the WSDL (162). Next, the root node of an XML specification for the WSDL is written out (164). The services of the WSDL are retrieved (166). For each service found (168), the service element is written out to the XML specification (170) and the bindings for the service are retrieved (172). For each binding found (174), the port types for the binding are retrieved (175). For each port type found (176), the port type element is written out to the XML specification (177) with a binding attribute added and the operations of the WSDL are retrieved (178). For each operation found (180), the operation element is written out to the XML specification (182) and input message schema type parts are retrieved (184). For each part found (186), the parameter of the input message is written out to the XML specification (188) and the schema type of the input message is processed (190). The steps of retrieving (162, 166, 172, 175, 178, 184) are sub-steps of querying the parsed WSDL (154) and may be performed by the WSDL query module 104.

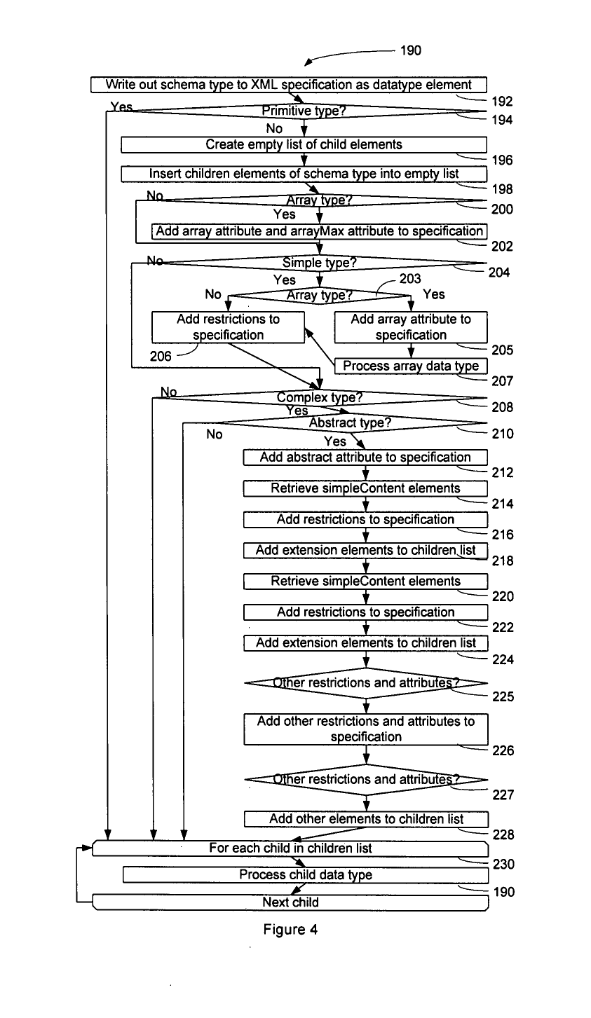

FIG. 4 shows in a flowchart an example of a method of processing a schema type of an input message (190), in accordance with an embodiment of the WSDL transformation system 100. The method (190) begins with writing out schema type to the XML specification as a “datatype” element (192), filling in the name, type, namespace, is Array, and simpleJavaType attributes. A namespace attribute may be omitted if the type is a primitive datatype. A min attribute may be added if the minOccurs attribute is set in the WSDL. If the datatype is not a primitive datatype (194), then an empty list of child elements of the schema type is created (196) and children element of the schema type are inserted into the empty list (198). If the schema type is an array (200), then an array attribute and an arrayMax attribute are added to the XML specification (202). Otherwise (200), if the schema type is a simpleType (204), then if the schema type is an array (203), then an array attribute and an arrayMax attribute are added to the XML specification (205) and the schema type of the data type of the array is processed (207). Otherwise (204), If the schema type is not an array (203), then restrictions are added to the XML specification (206). If the schema type is a complexType (208), then if the schema type is an abstract type (210), then an abstract attribute is added to the specification (212). The simpleContent elements are retrieved (214), simpleContent restrictions are added to XML specification (216) and simpleContent extension elements are added to the children list (218). The complexContent elements are retrieved (220), complexContent restrictions are added to XML specification (222) and complexContent extension elements are added to the children list (224). If there are other restrictions and attributes in the WSDL (225), these may be added to the XML specification (226). If there are other child elements in the WSDL (227) these are added to the children list (228). Such child elements may include group, choice, sequence, simpleContent, etc., elements that make up the complexContent element. For each child in the children list (230), the child schema type is processed (190).

In one embodiment, the method of processing schema types (190) is recursive. A UI restriction may be placed to limit the depth of recursion to X, where X is an integer greater than 0. In one embodiment, it has been empirically determined that 8 levels of recursion is a limit for a BI UI to prevent performance problems. Different UI may have different levels of thresholds for recursion depth. A recursion counter may be added to the method of processing schema types (190), such that step (194) of may be modified to include an “if the recursion depth is less than X”. Should the recursion depth pass the maximum depth limit X, then processing stops and optionally, a warning message could be displayed that for UI performance reasons, this WSDL is too complex to convert to a unified XML specification.

The WSDL transformation system 100 advantageously allows BI system users to enter data and map event data from agents to: (a) Document-Literal style web service methods, (b) to both Document-Literal and RPC-Encoded web services that use XML Schema Simple and Complex types as parameters, and (c) additional primitive data types (such as boolean, float, double, string, date, time, date/Time, decimal, etc. Other primitive data types may also be implemented) and derived data types (such as integer, int, long, short, byte, negativeInteger, positiveInteger, unsignedLong, unsignedInt, unsignedShort, unsignedByte, and normalizedString, etc. Other derived data types may also be implemented). The parameters for the web service method are described in an intermediate XML specification that breaks them down into a hierarchy until primitive types an/or derived types are obtained; in the UI, at the lowest level in the hierarchy, primitive and derived types are displayed. The users' input of values or agent data is saved, and at runtime, the XML specification is used to determine the location of the data in the web service request. Advantageously, the XML specification may also be used to dynamically build the web service request using Java classes representing the simple and complex types, which may be modified using Java reflection.

The following is an example of a WSDL description of a Document-Literal style web service:

<?xml version=“1.0” encoding=“UTF-8” ?>

| | |
|---|---|
| - | <wsdl:definitions |

```
    xmlns:http=“http://schemas.xmlsoap.org/wsdl/http/”
    xmlns:soap=“http://schemas.xmlsoap.org/wsdl/soap/”
    xmlns:s=“http://www.w3.org/2001/XMLSchema”
    xmlns:soapenc=“http://schemas.xmlsoap.org/soap/encoding/”
    xmlns:tns=“http://tempuri.org/WebService6/Service1”
    xmlns:tm=“http://microsoft.com/wsdl/mime/textMatching/”
    xmlns:mime=“http://schemas.xmlsoap.org/wsdl/mime/”
    targetNamespace=“http://tempuri.org/WebService6/Service1”
    xmlns:wsdl=“http://schemas.xmlsoap.org/wsdl/”>
  - <wsdl:types>
    - <s:schema elementFormDefault=“qualified”
        targetNamespace=“http://tempuri.org/WebService6/Service1”>
      - <s:element name=“trigger”>
        - <s:complexType>
          - <s:sequence>
                <s:element minOccurs=“0” maxOccurs=“1”
                name=“theDate” type=“s:dateTime” />
                <s:element minOccurs=“1” maxOccurs=“1”
                name=“Content” type=“tns:Content1” />
            </s:sequence>
          </s:complexType>
        </s:element>
      - <s:complexType name=“Content1”>
        - <s:sequence>
                <s:element minOccurs=“1” maxOccurs=“1”
              name=“Approval” type=“tns:ApprovalEnum” />
                <s:element minOccurs=“1” maxOccurs=“1”
              name=“Items” type=“tns:ArrayOfItem” />
          </s:sequence>
        </s:complexType>
      - <s:simpleType name=“ApprovalEnum”>
        - <s:restriction base=“s:string”>
            <s:enumeration value=“approved” />
            <s:enumeration value=“preapproved” />
            <s:enumeration value=“denied” />
          </s:restriction>
        </s:simpleType>
      - <s:complexType name=“ArrayOfItem”>
        - <s:sequence>
                  <s:element minOccurs=“1”
              maxOccurs=“unbounded” name=“Item”
              type=“tns:Item” />
          </s:sequence>
      </s:complexType>
      - <s:complexType name=“Item”>
        - <s:sequence>
                <s:element minOccurs=“1” maxOccurs=“1”
              name=“Quantity” type=“s:string” />
                <s:element minOccurs=“0” maxOccurs=“1”
              name=“Colour” type=“tns:Colours” />
                <s:element minOccurs=“1” maxOccurs=“1”
              name=“SalesTeam” type=“tns:ArrayOfSales”
              />
          </s:sequence>
        </s:complexType>
      - <s:simpleType name=“Colours”>
        - <s:restriction base=“s:string”>
            <s:enumeration value=“Red” />
            <s:enumeration value=“Blue” />
            <s:enumeration value=“Green” />
            <s:enumeration value=“Yellow” />
          </s:restriction>
        </s:simpleType>
      - <s:complexType name=“ArrayOfSales”>
        - <s:sequence>
                  <s:element minOccurs=“1”
              maxOccurs=“unbounded” name=“Sales”
              type=“tns:Sales” />
          </s:sequence>
        </s:complexType>
      - <s:complexType name=“Sales”>
        - <s:sequence>
              <s:element minOccurs=“1” maxOccurs=“1”
              name=“Name” type=“s:string” />
          </s:sequence>
        </s:complexType>
      - <s:element name=“triggerResponse”>
        - <s:complexType>
          - <s:sequence>
                <s:element minOccurs=“0” maxOccurs=“1”
                  name=“triggerResult” type=“s:string” />
            </s:sequence>
          </s:complexType>
        </s:element>
      </s:schema>
    </wsdl:types>
  - <wsdl:message name=“triggerSoapIn”>
      <wsdl:part name=“parameters” element=“tns:trigger” />
    </wsdl:message>
  - <wsdl:message name=“triggerSoapOut”>
      <wsdl:part name=“parameters” element=“tns:triggerResponse”
        />
    </wsdl:message>
  - <wsdl:portType name=“Service1Soap”>
    - <wsdl:operation name=“trigger”>
        <wsdl:input message=“tns:triggerSoapIn” />
        <wsdl:output message=“tns:triggerSoapOut” />
      </wsdl:operation>
    </wsdl:portType>
  - <wsdl:binding name=“Service1Soap” type=“tns:Service1Soap”>
```

<soap:binding

```
        transport=“http://schemas.xmlsoap.org/soap/http”
        style=“document” />
    - <wsdl:operation name=“trigger”>
```

<soap:operation

```
            soapAction=“http://tempuri.org/WebService6/Service1/
          trigger” style=“document” />
      - <wsdl:input>
          <soap:body use=“literal” />
        </wsdl:input>
      - <wsdl:output>
          <soap:body use=“literal” />
        </wsdl:output>
      </wsdl:operation>
    </wsdl:binding>
  - <wsdl:service name=“Service1”>
      <documentation xmlns=“http://schemas.xmlsoap.org/wsdl/”
        />
    - <wsdl:port name=“Service1Soap” binding=“tns:Service1Soap”>
```

<soap:address

```
            location=“http://localhost/WebService6/Service1.asmx” />
      </wsdl:port>
    </wsdl:service>
  </wsdl:definitions>
```

The following is an example of the corresponding XML specification that is generated by the WSDL transfomation system 100 to describe the same web service:

```
  <?xml version=“1.0” encoding=“UTF-8” ?>
- <WSDL>
  - <Service name=“Service1”>
    - <PortType name=“Service1Soap” type=“Service1Soap”
        Binding=“SOAPBindingImpl”>
      - <Operation name=“trigger”>
        - <Parameter Name=“parameters” Type=“trigger”
            SimpleJavaType=“false” isArray=“false”
            Namespace=“http://tempuri.org/WebService6/Service1”>
              <Datatype Name=“theDate” Type=“dateTime”
              SimpleJavaType=“true” min=“0” isArray=“false”
              />
            - <Datatype Name=“Content” Type=“Content1”
              SimpleJavaType=“false” isArray=“false”
              Namespace=“http://tempuri.org/WebService6/
              Service1”>
            - <Datatype Name=“Approval”
                Type=“ApprovalEnum”
                SimpleJavaType=“false” isArray=“false”
                Namespace=“http://tempuri.org/WebService6/
                Service1”>
                <base>string</base>
                      <enumeration>approved,preapproved,
                      denied</enumeration>
              </Datatype>
            - <Datatype Name=“Items”
                Type=“ArrayOfItem”
                SimpleJavaType=“false” isArray=“false”
                Namespace=“http://tempuri.org/WebService6/
                Service1”>
                - <Datatype Name=“Item” Type=“Item”
                  SimpleJavaType=“false” isArray=“true”
                  arrayMax=“2147483647”
                  Namespace=“http://tempuri.org/Web
                  Service6/Service1”>
                      <Datatype Name=“Quantity”
                    Type=“string”
                  SimpleJavaType=“true”
                    isArray=“false” />
                - <Datatype Name=“Colour”
                    Type=“Colours”
                    SimpleJavaType=“false” min=“0”
                    isArray=“false”
                    Namespace=“http://tempuri.org/
                    WebService6/Service1”>
                    <base>string</base>
                      <enumeration>Red,Blue,Green,
                      Yellow</enumeration>
                  </Datatype>
                - <Datatype Name=“SalesTeam”
                    Type=“ArrayOfSales”
                    SimpleJavaType=“false”
                    isArray=“false”
                    Namespace=“http://tempuri.org/
                    WebService6/Service1”>
                  - <Datatype Name=“Sales”
                      Type=“Sales”
                      SimpleJavaType=“false”
                      isArray=“true”
                      arrayMax=“2147483647”
                      Namespace=“http://tempuri.org/
                      WebService6/Service1”>
                        <Datatype Name=“Name”
                        Type=“string”
                        SimpleJavaType=“true”
                        isArray=“false” />
                    </Datatype>
                  </Datatype>
                </Datatype>
              </Datatype>
            </Datatype>
          </Parameter>
        </Operation>
      </PortType>
    </Service>
  </WSDL>
```

Advantageously, by creating a common, “simpler-than-WSDL”, XML specification that describes the web service methods, the WSDL transformation system 100 allows a BI UI to more easily build an input form for the user. The specification “breaks down” the simple and complex types in the web service WSDL into primitive and derived data types; then the BI displays HTML suitable for the user to enter data manually or map primitive SQL and OLAP data retrieved by the agent into the web service parameters. For example, an XML Schema enumeration may be represented as an HTML dropdown list; an XML Schema choice may be represented by a group of HTML radio buttons; hint text will indicate whether there are restrictions on values that may be entered for a particular field.

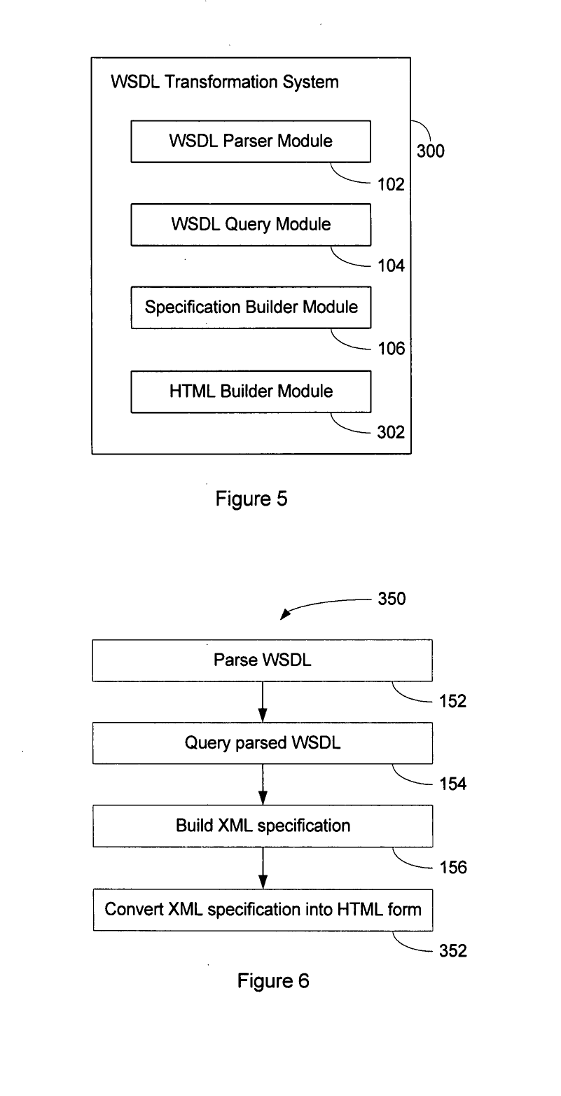

FIG. 5 shows in a component diagram another example of a WSDL transformation system 300, in accordance with an embodiment of the present invention. The WSDL transformation system 300 comprises the WSDL parser module 102, the WSDL query module 104, the specification builder module 106 and an HTML builder module 302 for converting the XML specification into an HTML “tree” control comprising HTML input elements for leaf data type nodes in the specification. The datatype nodes are either data types or one of the following WSDL elements that can be represented as an HTML input element:

| WSDL element | HTML input element |
|---|---|
| Extension - Enumeration | Drop down box |
| Extension - Choice | Radio button |
| Primitive type | Text box |
| Derived type | Text box |
| Simple type | Text box or |
| | Tree control - leaf nodes are one of above |
| Complex type | Tree control - leaf nodes are one of above |
| Restrictions | Use these to validate the data entered; |
| | for example, “minOccurs = 1” means an |
| | occurrence of the event is mandatory; |
| | “minOccurs = 0” means an occurrence of the |
| | event is optional. |
| Abstract parameter | Drop down list of valid concrete types |
| Recursive parameters | Only list minimum number of levels. |

If an array or repeating elements are encountered in the XML specification, they are converted into HTML form by repeating the data type for the array or repeating element. Optionally, an HTML mechanism may be supplied to allow users to specify how many elements of the array or repeating element will receive input.

For the purposes of the method to build a unified XML specification, the concept of an array in an RPC web services is different than a document style web service. The following example shows a stringArray complex type described in a WSDL for an RPC-Encoded web service:

```
<complexType name=“stringArray”>
  <complexContent>
    <restriction base=“SOAP-ENC:Array”>
      <attribute wsdl:arrayType=“xsd:string[ ]”
      ref=“SOAP-ENC:arrayType”/>
    </restriction>
  </complexContent>
</complexType>
```

However, in a document style web service, an array is considered to be an element with a maxOccurs attribute set to unbounded, or to a number greater than 1 (1 is the default if the attribute is missing). In this example, the stringArrayItem element is flagged as an array, since it may appear multiple times in the sequence.

```
<complexType name=“stringArray”>
  <sequence>
    <element name=“stringArrayItem” nillable=“true”
    type=“xsd:string” maxOccurs=“unbounded”/>
    <element name=“stringArrayItemCount” type=“xsd:int” />
  </sequence>
</complexType>
```

FIG. 6 shows in a flowchart another example of a method of transforming WSDL specifications into extensible markup language (XML) specifications (350), in accordance with an embodiment of the WSDL transformation system 300. The method (350) begins with parsing a WSDL of a web service (152). Next, the parsed WSDL is queried (154) to determine the services, bindings, ports, operations and messages of the WSDL, and what data types make up those messages. Next, a unified XML specification is build for the WSDL (156) based upon the queried information. Next, the XML specification is converted into an HTML “tree” control (352) comprising HTML input elements for leaf data type nodes in the specification.

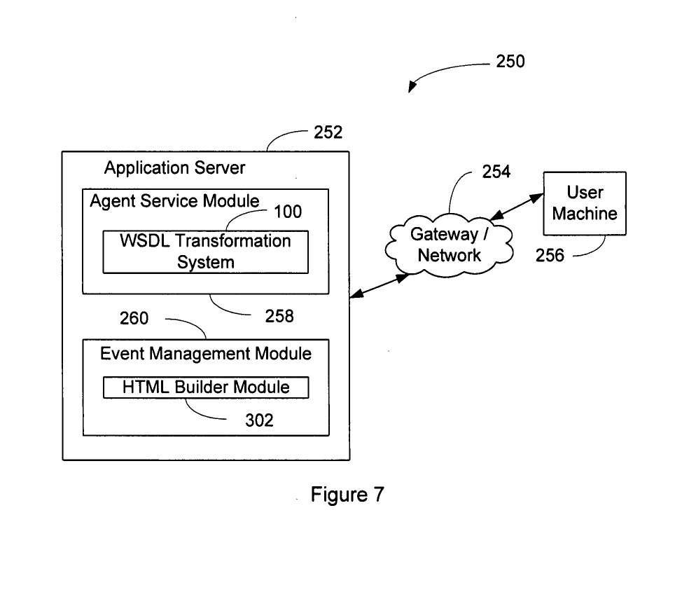

FIG. 7 shows in a component diagram an example of a system environment 250 that may implement the WSDL transformation systems 100, 300. The system environment 250 comprises a web application server 252, a gateway or network 254 and a client machine 256. The web application server 252 hosts a web application 258 that is used by the client machine 256. The web application 258 comprises an agent service module 260 for implementing an agent task or process and an event management module 262 for implanting a development environment. The WSDL transformation system 100 may be implemented in the agent service module 260. In one embodiment, the WSDL transformation system 300 is implemented in the web application 258 by having the components comprising the WSDL transformation system 100 implemented in the agent service module 260, while the HTML builder module 302 is implemented in the event management component 262. Alternatively, the WSDL transformation system 300 may be implemented separately, with the WSDL transformation system 100 called by the agent service module 260 and the HTML builder module 302 called by the event management component 262.

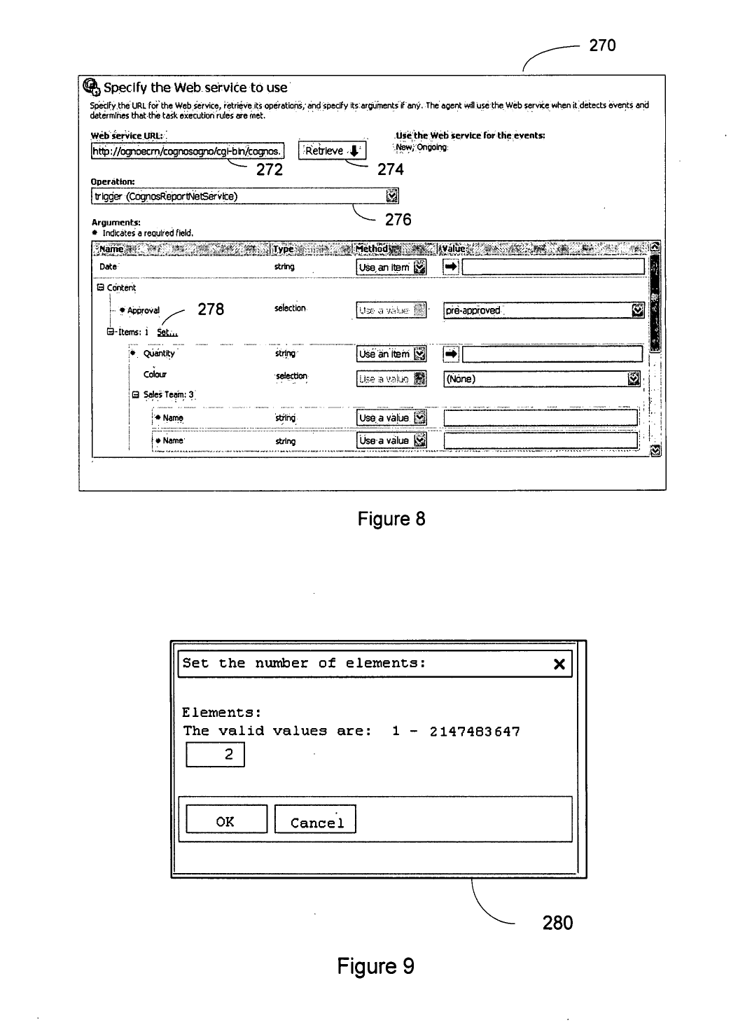

FIG. 8 shows in a screenshot an example of a WSDL transformation system UI 270 for a BI UI specification, in accordance with an embodiment of the WSDL transformation system 100. The WSDL transformation system UI 270 may be implemented in the event management module 262 of the web application 258 or separately and called by the event management module 262. The UI 270 shows a text box 272 where a user may enter a URL for the web service WSDL, and a Retrieve button 274 which when clicked will cause the XML specification to be produced in order to render the subsequent Operation drop-down list 276. The first operation chosen will display an input message to the web service operation (e.g., trigger). Primitive types described in the XML specification are preferably represented as HTML input elements (e.g., textbox, drop-down lists). Array types described in the unified XML specification may provide a hyperlink 278 to allow users to choose the number of elements in the array in which to map data. The hyperlink 278 will present the dialog shown in FIG. 9.

FIG. 9 shows in a screenshot an example of a UI dialog for specifying a number of array elements 280, in accordance with an embodiment of the WSDL transformation system 100. If some elements in the XML specification contain an attribute indicating an array, the higher level (or parent) element in the display will optionally provide a means to specify how many elements within the array should be filled with data. The UI 270 allows the user to supply a value for child elements that have the array attribute set to true in the xml specification. If the user chooses to specify the number of array elements they wish to satisfy with data, this value may be supplied via the dialog 280.

The systems and methods according to the present invention described above may be implemented by any hardware, software or a combination of hardware and software having the above described functions. The software code, either in its entirety or a part thereof, may be stored in a computer readable memory. Further, a computer data signal representing the software code that may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention.

What is claimed is:

1. A web service description language (WSDL) transformation system for mapping web service parameters into primitive or derived data types, the WSDL transformation system comprising:
a WSDL parser module for parsing a WSDL of a web service;
a WSDL query module for querying the parsed WSDL; and
a specification builder module for building a unified XML specification for the WSDL.

2. The WSDL transformation system as claimed in claim 1, wherein the WSDL parser module ensures that the WSDL is complete and valid.

3. The WSDL transformation system as claimed in claim 1, wherein the WSDL parser module creates a list of XML schema data types described in the WSDL.

4. The WSDL transformation system as claimed in claim 3, wherein the XML schema data types comprise at least one of simple types or complex types.

5. The WSDL transformation system as claimed in claim 1, wherein the WSDL query module provides a query interface to interrogate what services, bindings, ports, operations, and messages are available from the parsed WSDL, and what data types make up those messages.

6. The WSDL transformation system as claimed in claim 1, wherein the specification builder module uses the WSDL query module to interrogate the structure of a web service request described in the WSDL.

7. The WSDL transformation system as claimed in claim 1, wherein the specification builder module builds a well-formed XML document specification for that WSDL.

8. The WSDL transformation system as claimed in claim 1, further comprising a hypertext markup language (HTML) builder module for converting the XML specification into an HTML “tree” control comprising HTML input elements for leaf data type nodes in the XML specification.

9. The WSDL transformation system as claimed in claim 8, wherein the data type nodes comprise at least one of:
primitive data types;
derived data types;
extension—enumeration elements;
extension—choice elements;
simple data types;
complex data types;
restrictions for validating entered data;
abstract parameters; and
recursive parameters.

10. A method of mapping web service parameters into primitive or derived data types, the method comprising the steps of:
parsing a WSDL of a web service;
querying the parsed WSDL; and
building a unified XML specification for the WSDL.

11. The method as claimed in claim 10, wherein the step of building unified XML specification for the WSDL comprises the steps of:
retrieving web service schema types of the WSDL;
writing out a root node of the XML specification for the WSDL; and
retrieving services of the WSDL, for each service found:
writing out a service element to the XML specification;
retrieving bindings for the service, for each binding found:
retrieving port types for the service, for each port type found:
writing out a port type element to the XML specification with a binding attribute; and
retrieving operations of the WSDL, for each operation found:
writing out an operation element to the XML specification; and
retrieving input message schema type parts, for each part found:
writing out a parameter of the input message to the XML specification; and
processing a schema type of the input message.

12. The method as claimed in claim 11, wherein the step of processing a schema type of the input message comprises the steps of:
writing out schema type to the XML specification as a “datatype” element;
if the datatype is not a primitive or derived type:
creating an empty list of child elements of the schema type;
inserting children element of the schema type are inserted into the empty list;
if the schema type is an array:
adding an array attribute is added to the XML specification;
if the schema type is a simpleType:
if the schema type is an array:
adding an array attribute is added to the XML specification; and
processing the schema type of the data type of the array; and
if the schema type is not an array:
adding array restrictions to the XML specification if the schema type is not an array; and
if the schema type is a complexType:
adding an abstract attribute to the XML specification if the schema type is an abstract type;
retrieving simpleContent elements;
adding simpleContent restrictions to the XML specification;
adding simpleContent extension elements to the children list;
retrieving complexContent elements;
adding complexContent restrictions to the XML specification;
adding complexContent extension elements to the children list;
adding other restrictions and attributes to the XML specification; and
adding other child elements to the children list; and
processing a child schema type for each child in the children list.

13. The method as claimed in claim 12, wherein the step of writing out the schema type to the XML specification comprises the steps of filling in at least one of a name, type, is Array and simpleJavaType attributes of the schema type.

14. The method as claimed in claim 13, wherein the step of writing out the schema type to the XML specification further comprises the steps of filling at least one of a namespace, an arrayMax, an abstract attribute and a min attribute.

15. The as claimed in claim 12, wherein the other child elements added to the children list includes at least one of group, choice, sequence or simpleContent elements that make up the complexContent element.

16. The method as claimed in claim 10, further comprising the step of:
converting the XML specification into an HTML “tree” control comprising HTML input elements for leaf data type nodes in the specification.

17. The method as claimed in claim 16, wherein the data type nodes comprise at least one of:
primitive data types;
derived data types;
extension—enumeration elements;
extension—choice elements;
simple data types;
complex data types;
restrictions for validating entered data;
abstract parameters; and
recursive parameters.

18. A memory containing computer executable instructions that can be read and executed by a computer for carrying out a method of mapping web service parameters into primitive data types, the method comprising the steps of:
parsing a WSDL of a web service;
querying the parsed WSDL; and
building unified XML specification for the WSDL.

19. A carrier carrying a propagated signal containing computer executable instructions that can be read and executed by a computer, the computer executable instructions being used to execute a method of mapping web service parameters into primitive data types, the method comprising the steps of:
parsing a WSDL of a web service;
querying the parsed WSDL; and
building a unified XML specification for the WSDL.
